(19) United States
(12) Patent Application Publication
(10) Pub. No.: US 2012/0274441 A1
(43) Pub. Date: Nov. 1, 2012

(54) Power Outlet with Restricted Access

(75) Inventors: Dave Dale Birchbauer, Waukesha, WI (US); Damien D. Rushing, Racine, WI (US)

(73) Assignee: Honeywell International Inc., Morristown, NJ (US)

(21) Appl. No.: 13/097,119

(22) Filed: Apr. 29, 2011

(51) Int. Cl. G05B 19/00; G06F 1/16

(52) U.S. Cl. 340/5.2; 361/679.02

(57) ABSTRACT

An apparatus to provide controlled electrical energy in a substantially public setting includes a power control unit. The unit includes credential entering circuitry which, upon authentication, provides access to a supply of AC-type electrical energy which can be used to recharge batteries of a vehicle. Authentication can be carried out locally, or at a displaced access control system. An access credential can be entered via a card reader or a wires receiver.

### FIELD

The application pertains to controllable AC-type outlets. More particularly, the application pertains to such outlets which are coupled to security or monitoring systems where the respective outlet(s) can be activated by an access control card, or a wireless device.

### BACKGROUND

There is currently great interest in hybrid and electric cars. Viability of such vehicles will depend, in part, on the availability of infrastructure that makes recharging the vehicles easy and secure.

It is predicted that hybrid and electric cars will soon be capable of using standard 110/220 VAC house current for recharging. This provides opportunities for businesses, such as work places, parking lots, motels and private residences such as condos, apartments and even houses to provide controlled electrical outlets in parking areas for recharging cars.

Theft of electricity is obviously an issue. It will be necessary to prevent unauthorized users, such as non-resident/non-employees from plugging into an outlet in an open parking area, or, to prevent an unauthorized user, who parks next to an authorized vehicle and switches recharging plugs, from appropriating electricity charged to another's account.

### BRIEF DESCRIPTION OF THE DRAWINGS

FIG. 1 is a block diagram of a controllable outlet in accordance herewith;

FIG. 2 is a diagram illustrating exemplary usage of the apparatus of FIG. 1; and

FIG. 3 illustrates additional details of the apparatus of FIG. 1.

### DETAILED DESCRIPTION

While disclosed embodiments can take many different forms, specific embodiments thereof are shown in the drawings and will be described herein in detail with the understanding that the present disclosure is to be considered as an exemplification of the principles thereof as well as the best mode of practicing same, and is not intended to limit the application or claims to the specific embodiment illustrated.

In a disclosed embodiment, non-billing security can be provided for electrical outlets using an access control system. In one aspect, in order to prevent un-authorized usage of outlets in a parking area, an access card and card reader, carried by an outlet, or power, control unit, can be associated with a specific outlet or outlets. Once an authorizing card has been scanned, and, accepted the outlet(s) can be energized. The outlet control unit and the associated access control system can detect when current flow through the outlet stops or slows, either by being unplugged or when charging is complete. The outlet can then be de-energized preventing unauthorized users from accessing and appropriating electrical energy from the outlet.

The control system, or the outlet control unit, can provide alarms and logging functions to notify owners of usage (authorized and unauthorized). The control system can also provide information from attached meters for billing. Outlet activation can be prevented during specific times, such as when a resident is away or when peak energy rates are applicable by the control system, and/or the outlet control unit.

An input signal can be provided to the outlet control unit that will activate or deactivate access to the power. The outlet control unit can include predetermined, security related functionality. For example, the following can be detected: When power is disconnected, indicating potential theft by unplugging current user and plugging in an unidentified user; when charging is complete, indicated by ‘flat-line’ of low current; and when current usage spikes, indicating that another user may have spliced into an existing charging line.

In another aspect, the outlet control unit can determine peak and low level current usage to notify the access control system when the current usage changes state. For example, when current becomes too high, an alarm can be generated. Alternately, when current goes low, an event can be generated to shut off the current flow to the outlet.

Components can include a security control system along with the outlet control unit. The control system can be programmed to monitor and manage the outlet control unit. The outlet control unit can include a card reader, power outlet, outlet control circuits, power/current monitor and an optional meter. The card reader can respond to magnetic, optical or RF-type cards, all without limitation. The unit can also include a wireless receiver for receipt of authorizing signals from cell phones or other wireless control devices, all without limitation.

Power control units can be located throughout parking facilities. Parking facilities can include outdoor lots, indoor lots, garages or even street parking spaces. Unit control circuits can energize or de-energize the outlet (110/220) via an inbound authorizing signal. The inbound signal can come from the authorizing, or access control system. The outlet, or power, control unit can monitor the current consumption from the outlet. If the current spikes, indicating someone splicing into the charging line, or drops to a low set point, indicating the vehicle is unplugged or charging is complete, the unit will output a signal to the control system.

Normally the outlet is in a de-energized state. When a valid card is read (via the reader) and authorization is provided, the control system signals the outlet control unit to energize the outlet. Other circuitry in the control system, or the outlet control unit, may energize or de-energize the outlet based on other conditions where a card read is not needed.

When the outlet is in an energized state, the control system can de-energize (send a signal) to the outlet in response to detecting various conditions. These can include:

1—If the time allotted expires

2—The time crosses into a high billing (time of use) period

3—A signal is received from a current monitor indicating a possible error condition, completion of charge or a disconnection

4—Another card swipe of an unauthorized user

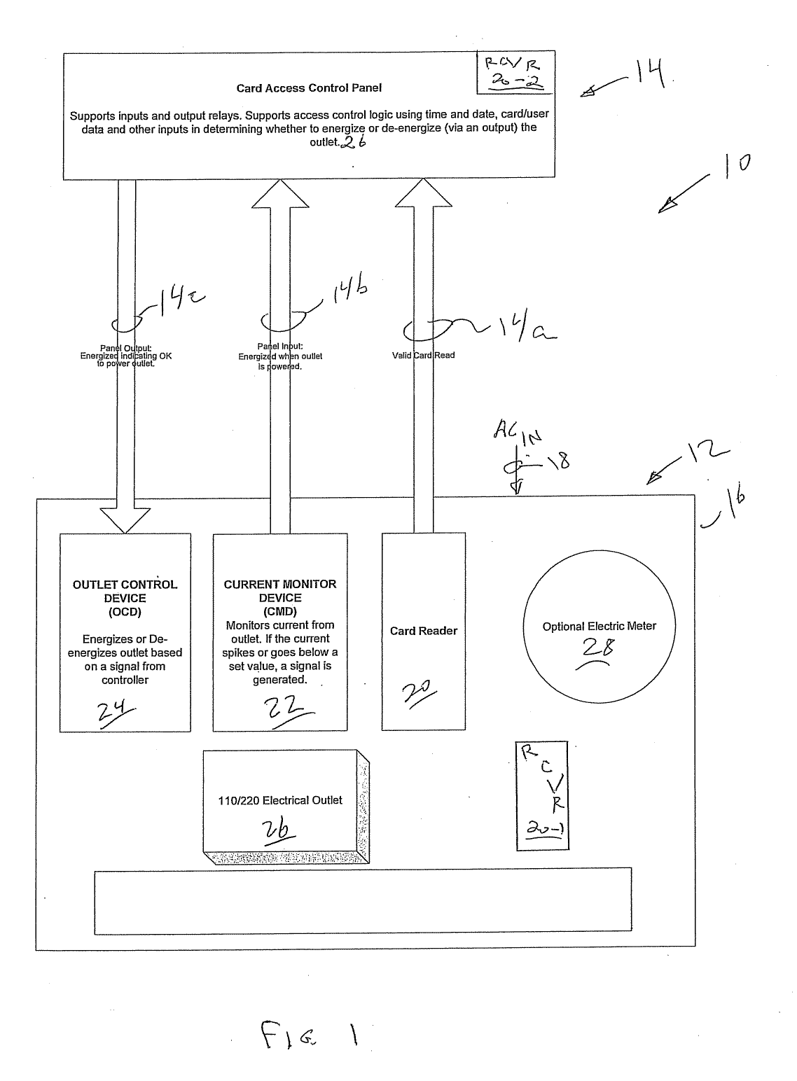

FIG. 1 illustrates an apparatus 10 which includes an outlet control unit 12. Unit 12 is coupled to a card access control panel 14 via wired or wireless links 14a, 14b and 14c. While illustrated separately, it will be understood that the exact communications protocol is not a limitation hereof. Nor is the type of medium a limitation. The links 14a, 14b and 14c could, for example be implemented using a dedicated communications channel, or, an Internet protocol, without limitation.

Unit 12 includes a secure housing 16. Housing 16 carries a card reader 20 to provide an access credential, a current monitoring device 22, an outlet control device 24, and an electrical outlet 26 to which a vehicle to be recharged can be coupled. An optional electric meter 28 can also be provided.

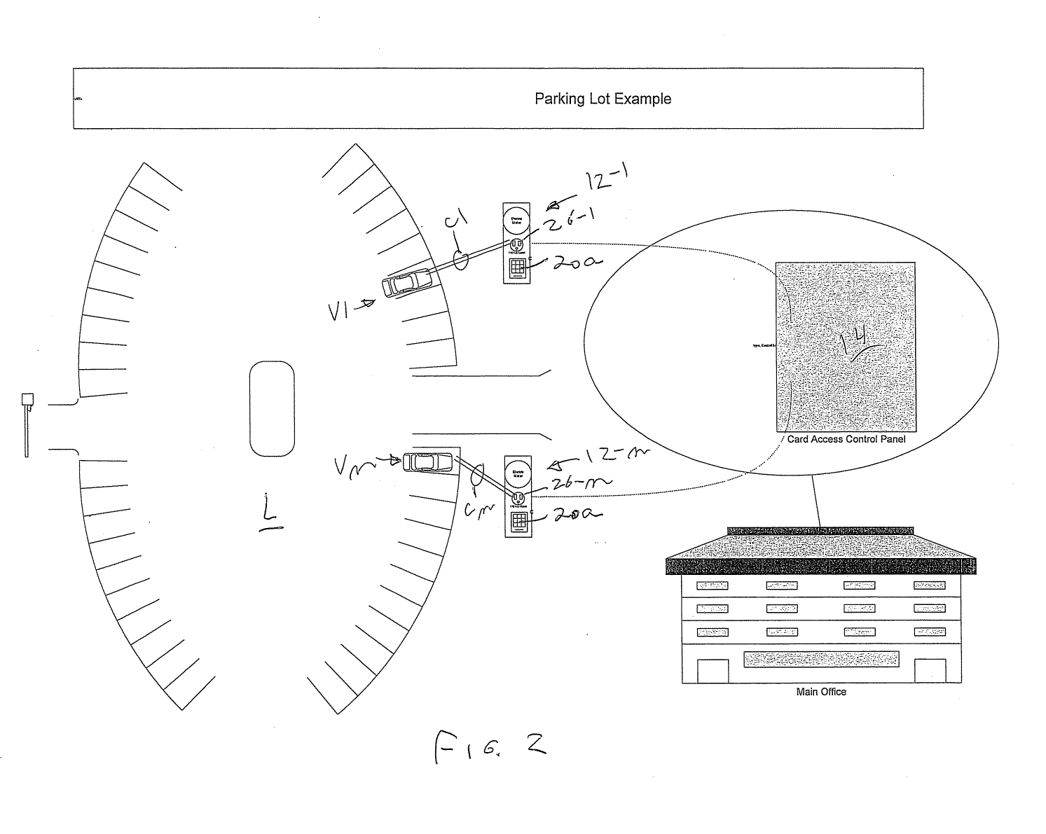

The unit 12 can also support various types of user input devices. For example, a key pad 20a, best seen in FIG. 2, can also be provided as well as other types of input, or output devices, without limitation. For example, non-contact electronic credential providing devices, such as cellular-type devices, which wirelessly communicate with the unit 12 or control panel 14 via receivers such as 20-1 and 20-2, come within the spirit and scope hereof.

The current monitoring device 22 monitors current from the outlet 26. If the current spikes or falls below a pre-set threshold, an indicating signal can be forwarded to the panel 14 via link 14b. The outlet control device 24 energizes or de-energizes the outlet 26 in response to a control signal from the panel 14 via link 14c.

FIG. 2 illustrates an implementation of the system 10 in a parking lot L. A plurality of units 12-1, 12-2...12-n can be distributed throughout the parking lot, or garage, L. Owner's of vehicles, such as V1, V2 . . . Vn in need of a charge can provide access information via card reader 20, keypad 20a, or receivers 20-1, 20-2 at the associated outlet control unit 12-1, 12-2 . . . 12-n. Once the received access information is validated, or authentified, the control system, or panel, 14, via link 14c and outlet control device 24 can activate the outlet 26 to charge the battery(s) on the respective vehicle Vi.

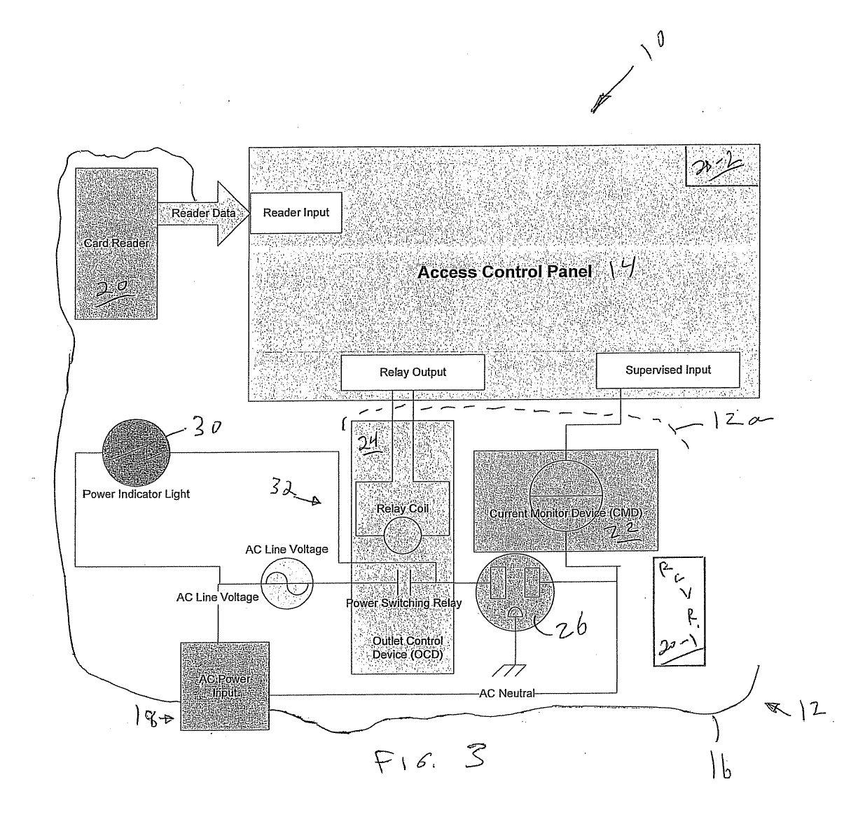

FIG. 3 illustrates additional aspects of the system 10. Previously discussed elements are identified with the same identification numerals as above.

The unit 12 can include a power indicator light 30 along with a switching circuit 32, which could be implemented as an electro-mechanical relay, or one or more solid state switches, all without limitation. It will also be understood that the components of unit 12 can be implemented, at least in part with a programmable processor and associated control programs, pre-stored in non-volatile memory, indicated at 12a. Furthermore, functionality from the control panel 14 can be incorporated into unit 12 for stand-along operation.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims. Further, logic flows depicted in the figures do not require the particular order shown, or sequential order, to achieve desirable results. Other steps may be provided, or steps may be eliminated, from the described flows, and other components may be add to, or removed from the described embodiments.

1. An outlet control unit comprising:
a housing;
a device to receive an access requesting input, carried by the housing; and
control circuitry, carried by the housing, and responsive to the access requesting input to switch electrical energy to an output port carried by the housing.

2. A unit as in claim 1 which includes a port to communicate with a displaced access control system.

3. A unit as in claim 1 where the device includes at least one of a card reader, or a wireless receiver.

4. A unit as in claim 3 where the card reader responds to at least one of a magnetic input, an optical input or an RF input.

5. A unit as in claim 3 where the control circuitry includes a programmed processor and associated control programs to activate energy switching circuits to coupled electrical energy from a source to the output port.

6. A unit as in claim 3 where the control circuits include current monitoring circuitry.

7. A unit as in claim 2 where the control circuitry transmits the access requesting input to the access control system for authentication.

8. A unit as in claim 7 where the control circuitry responds to a received authentication signal, from the access control system to switch electrical energy to the output port.

9. A unit as in claim 8 where the device includes at least one of a card reader, or a wireless receiver.

10. A unit as in claim 9 where the control circuitry monitors current flow from the output port and terminates that flow in response to at least one selected condition.

11. A unit as in claim 10 where the selected condition is from a class which includes current flow from the output port terminating, or, current flow from the output port dropping to a pre-selected value.

12. A unit as in claim 11 which includes a meter of current flow from the output port.

13. An energy dispensing apparatus comprising:
an outlet control unit with energy monitoring circuitry and an energy dispensing outlet; and
an access control system, wherein the control unit transfers access requesting information to the control system for authentication, and, in response to authentication, the control system transfers a dispensing indicium to the control unit, wherein the control unit, in response to the received dispensing indicium, activates the outlet to dispense electrical energy, and wherein dispensing is terminated in response to the energy monitoring circuitry detecting a predetermined condition.

14. An apparatus as in claim 13 where the control unit includes at least one of a card reader, or, a wireless receiver.

15. An apparatus as in claim 13 where the predetermined condition includes at least one of detecting termination of a current flow, detecting a current flow above a predetermined value, or, detecting a current flow below a different predetermined value.

16. A method comprising:
providing an access credential;
authenticating the credential, and responsive thereto, providing access by initiating a current flow;
monitoring the magnitude of the current flow, and responsive thereto, terminating access in response to at least one of, the current flow terminating, the current flow exceeding a predetermined value, or the current flow declining to a different predetermined value.
